(19) United States
(12) Patent Application Publication
(10) Pub. No.: US 2005/0027595 A1
(43) Pub. Date: Feb. 3, 2005

(54) Advertising system and method using lotto game

(76) Inventors: Jang-Hou Ha, Seoul (KR); Yong-Nam Ryu, Seoul (KR); Ju-Heon Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/813,708

(22) Filed: Mar. 30, 2004

(30) Foreign Application Priority Data
Jul. 30, 2003 (KR) 10-2003-52520

(51) Int. Cl. G06F 17/60; A63F 9/24; A63F 13/00; G06F 17/00; G06F 19/00

(52) U.S. Cl. 705/14; 463/17

(57) ABSTRACT

An advertising system and method using a lotto game. The advertising system provides a user with a free-of-charge lotto game in payment for the exposure of advertising messages, enables the user having a lotto-game subscription coupon manufactured by an advertiser to enjoy the free-of-charge lotto game such that it can encourage the user to aggressively view the advertising messages of the advertiser by himself or herself, resulting in the maximum advertising effect of the desired advertisement.

### BACKGROUND OF THE INVENTION

1. Field of the Invention

The present invention relates to an advertising system and a method thereof, and more particularly to an advertising system and method using a lotto game, which enables a user or customer having a subscription coupon or ticket for the lotto game to view an advertisement of an advertiser during a predetermined period of time, and provides the user with the lotto game free of charge, on the condition that the user having the subscription coupon or ticket recording a unique management number therein has visited a Web-site of an information service provider, and has entered the unique management number in a prescribed form of the Web-site, resulting in the maximum advertising effect of the desired advertisement.

2. Description of the Related Art

Internet symbolized by a World Wide Web (WWW) has greatly changed the life of human beings in various ways such as social, political, and economical aspects, etc., during a few short years, resulting in the new paradigm for Information Communication Societies. Presently, it is impossible to imagine the human life without the Internet in modern society.

With the increasing development of computer communication technologies, the spread of personal computers, and the greater use of super high-speed communication networks, users or subscribers can freely use the Internet anywhere they wish. With the widespread use of the Internet, many developers have conducted intensive research into online businesses over the Internet because the Internet has no limitation in space and time. In other words, following the current trend of rapidly growing digital communication technologies and the widespread use of the Internet, new commodities and services have recently appeared in the virtual space called the Internet. With the increasing demands for such commodities and services, there have been newly proposed a variety of online services and associated schemes, for example, an online fee settlement service, etc. Such online services have recently brought about a new online market available for a direct transaction between a provider and a customer over the Internet.

Therefore, an advertisement over the Internet (hereinafter referred to as an online advertisement) has become increasingly popular as a substitute for a typical offline advertisement such that transaction between a buyer and a seller is expedited more efficiently. A representative example of the online advertisement is a banner advertisement.

The banner advertisement composed of an image file is one of the most popular modes of advertising on the Internet, is configured in the form of a small-sized advertising window displayed on a Web page of a specific Web-site under contract with the advertiser, and is hyperlinked to a Web-site of the advertiser. Therefore, if a visitor clicks on the banner advertisement, he or she automatically moves to the advertiser's Web-site linked to the advertising window such that a more detailed advertisement will be displayed for the visitor's recognition.

However, the above-identified advertising method has a disadvantage in that the advertising window is spatially limited such that the amount of information displayable in the advertising window is also limited. Therefore, a plurality of advertisers make all possible effort to create a more distinctive advertising window using a more creative and shorter message to attract the visitor's attention.

Since the above-identified method for improving the advertising window's design has a limitation in increasing the number of user clicks, there has been newly proposed a point (or money) accumulation advertising method for accumulating a predetermined amount of cyber money for the user who clicks on the banner advertising window.

However, the above-identified point-accumulation advertising method accumulates a very small amount of money when the user clicks once on the advertising window, resulting in deterioration of user's interest. Therefore, as time goes by, the number of user clicks on the advertising window becomes lower, resulting in deterioration of the advertiser's desired advertising efficiency.

### SUMMARY OF THE INVENTION

One aspect of the present invention provides a computerized advertising system, comprising a server connected to the Internet. The server having a computer program configured to execute a method, which comprises: issuing one or more coupons for playing a lottery game to an advertiser, wherein the one or more coupons are designed to be electronically distributed; receiving a request for playing the lottery game from a lottery player having such a coupon; determining whether the player's coupon is valid for playing the lottery game; upon validation of the coupon, enabling to transmit data of an advertisement of the advertiser to a computer device of the player; and thereafter, permitting the player to play the lottery game. The method may further comprise purchasing one or more lottery game tickets from a lottery gaming authority. The server may comprise a code creator configured to create an identification code for each individual coupon, and wherein the identification code is used for the validation of the coupon. The server may comprise a lottery game manager configured to connect to a computer network of a lottery gaming authority and configured to coordinate the lottery game play.

Another aspect of the present invention provides a method of operating advertising services over a computer network. The method comprises: issuing one or more coupons for playing a lottery game to a service subscriber, wherein the one or more coupons are configured to be distributed to the public; receiving a request for playing the lottery game from a lottery player having such a coupon; determining whether the player's coupon is valid for playing the lottery game; upon validation of the coupon, enabling to transmit data of an advertisement of the subscriber to a terminal of the player; and thereafter, permitting the player to play the lottery game. The coupons may be electronic coupons. The coupons may be physical coupons. The coupons may be issued upon a request for such issuance by the subscriber. The coupons may be distributed to persons who are visiting the subscriber's web site or clicking a banner advertisement of the subscriber on a web site. Each coupon may have a unique identification code. The player's coupon may be validated based on information associated with the identification code.

In the above-described method of operating advertising services, the advertisement may be displayed on the terminal for a predetermined period of time. The advertisement data may be transmitted from a server belonging to the advertising service. The method may further comprise receiving the advertisement data from the subscriber prior to the receipt of the request. The advertisement data may be transmitted from a server belonging to the subscriber. The method may further comprise purchasing at least one lottery game ticket. The at least one lottery game ticket may be an electronic ticket. The at least one lottery game ticket may be purchased from a lottery gaming authority. The at least one lottery game ticket may be purchased prior to the permission to play the game. The at least one lottery game ticket may have pre-selected numbers for the lottery game. The player may select his own numbers for playing the lottery game as he desires. The at least one lottery game ticket may be purchased after the selection of the numbers and includes the player selected numbers. The method may further comprise informing the player as to whether he has won in the lottery game.

Another aspect of the present invention provides a method of playing a lottery game free of charge over a computer network. The method comprises: receiving a coupon for playing a free game of lottery, which may be made publicly available; connecting to a web site for the free lottery game play; transmitting via the computer network to the web site an identification code of the coupon for validation; upon validation, receiving advertisement data via the computer network; displaying an advertisement for a predetermined period of time; and thereafter, connecting to a lottery game free of charge.

Still another aspect of the present invention provides a computerized advertising system, comprising a server connected to a computer network. The server has a computer program configured to execute a method, which comprises: receiving a request for playing a lottery game free of charge, the request being electronically received from a computer device of a player via the computer network; transmitting or causing to transmit data of an advertisement to the computer device of the player, wherein the advertisement may be configured to be displayed in the computer device for a predetermined period of time; thereafter, permitting the player to play the lottery game free of charge via the computer device; and wherein the server comprises a lottery game coordinator configured to electronically purchase one or more lottery game tickets from a lottery gaming authority. This particular method and the system incorporating the method does not require coupons and processing relating to coupons. However, coupons and related processing steps may be incorporated. Also, the other methods and systems described in this summary and the detailed description of the invention may not include the use of the coupons and related processing steps even if all of the embodiments use the coupons.

A further aspect of the present invention provides a computerized advertising system, comprising a server connected to a computer network. The server has a computer program configured to execute a method, which comprises: receiving a plurality of electronic coupons issued by a computerized advertising service; transmitting the electronic coupons to the public via a computer network; causing a holder of one of the coupons to connect to a server hosting the advertising service; causing to transmit data of an advertisement to a computer device operated by the coupon holder, wherein the advertisement may be displayed on the computer device for a predetermined period; and allowing the coupon holder to play the lottery game free of charge through the server of the advertising service. The advertisement data may be transmitted to the computer device from the server hosting the advertising service. The advertisement data may be transmitted to the computer device from a server belonging to an advertiser of the advertisement.

In accordance with one aspect of the present invention, the above and other objects can be accomplished by the provision of an advertising apparatus using a lotto game, comprising: an advertiser server connected to an Internet; an operator system for issuing a plurality of online lotto-game subscription coupons having different unique management numbers upon receiving lotto-game subscription coupon issuance request information from the advertiser server over the Internet, receiving the lotto-game subscription request information from a user server over the Internet, identifying advertiser information on the basis of the unique management numbers entered by the user server, transferring a predetermined advertising message requested by the advertiser to the user server, advertising the predetermined advertising message using the user server, and providing a lotto-game screen image; and a plurality of affiliated-site servers for receiving an online lotto-game subscription coupon issued by the operator system over the Internet, and providing the user server visiting a predetermined Web-site with the lotto-game subscription coupon.

In accordance with another aspect of present invention, there is provided an advertising method using a lotto game, comprising the steps of: a) upon receiving a lotto-game subscription coupon issuance request from an advertiser, assigning unique management numbers to a plurality of lotto-game subscription coupons as many as the advertiser desires, and providing an advertiser's Web-site and an affiliated-site with the lotto-game subscription coupons having the unique management numbers; b) upon receiving a lotto-game subscription request from the user who receives the lotto-game subscription coupon from the advertiser's Web-site and the affiliated-site, and requesting the user to enter a unique management number marked on a corresponding lotto-game subscription coupon; c) verifying validity of the lotto-game subscription coupon upon receipt of the unique management number, and identifying the advertiser who has issued the corresponding lotto-game subscription coupon; d) advertising an advertising content requested by the advertiser; e) if the advertising content has been advertised, providing the user with a predetermined lotto-game image, and enabling the user to select a desired lotto number; f) purchasing a lotto lottery corresponding to the selected lotto number; and g) checking prize-winning result information, and transferring the user of the checked result information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conceptual diagram of an advertising system and method using a lotto game;

FIG. 2 is a view illustrating a configuration of an advertising system using a lotto game;

FIG. 3 is a detailed block diagram of the advertising system shown in FIG. 2;

FIG. 4 is a flow chart illustrating an advertising method using a lotto game;

FIGS. 5-7 are exemplary views illustrating screen images of the lotto game executable by the advertising method shown in FIG. 4;

FIG. 8 is a flow chart illustrating an advertising method using a lotto game; and

FIGS. 9-11 are exemplary views illustrating screen images of the lotto game executable by the advertising method shown in FIG. 8.

### DETAILED DESCRIPTION OF EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

Prior to describing the inventive advertising system and method using a lotto game, a lottery (hereinafter referred to as a lotto lottery) will be described in brief.

The lotto lottery serving as a substitute for a typical lottery ticket enables a user (i.e., a lottery customer) to manually select a desired lottery number using a dedicated network and a user's terminal, and is one of the most popular lotteries throughout the world.

In more detail, the lottery customer selects his or her desired numerals from among the numerals 1-45 using an OMR (Optical Mark Reader)-based game slip such that he or she can freely assign desired numerals to the lotto lottery. Then, the customer transfers the game slip containing the user's desired numerals (e.g., six numerals) to a lotto-lottery provider system using his or her terminal over a dedicated network in such a way that the lottery number is registered in the lotto-lottery provider system. In this way, if a total number of all the lotto lotteries sold by a closing deadline are summed up in real time, and a prescribed lottery system draws a lucky number from a specially designed box, the final ranking of winners is determined by comparing the lucky number with the individual lottery number. In other words, the more the same numerals between the lucky number and the individual lottery number, the higher the prize-winning amount of money.

The advertising system and method according to the present invention provides a user receiving a lotto-game subscription coupon with a lotto lottery on the condition that the user must see a predetermined advertising image such that it encourages the user to aggressively view the advertising image, resulting in the maximum advertising effect of the advertising message.

For reference, the above-identified advertising system and method is made available for a variety of lotto lotteries throughout the world, for example, the Korean Lotto 6/45 lottery and various kinds of lotto lotteries widely used in the United States, Canada, and Australia, etc.

For example, according to the Korean Lotto 6/45 scheme, provided that 6 numbers from among a plurality of numbers 1-45 are equal to the final lucky numbers, a customer having a corresponding lottery on which the same 6 numbers are recorded can win the first prize in the lottery. According to the PowerBall Lotto game in the United States, provided that only 5 numbers from among 53 numbers are equal to the final lucky numbers and only one number from among 42 numbers is found in the final lucky numbers, a customer having a corresponding lottery on which the same 6 numbers are recorded can win the first prize in the lottery. According to the Megamillion Lotto game, provided that 5 numbers from among 52 numbers are equal to the final lucky numbers and then only one number is found in the 52 numbers, a customer having a corresponding lottery ticket on which the same 6 numbers are recorded can win the first prize in the lottery.

The SuperBall 7 and PowerBall Lotto games widely used in Canada, and the Australian Lotto 6/45 game are a lotto game for selecting a prizewinner from among a plurality of customers in the same way as in the above-identified lottery methods. Although the aforementioned preferred embodiment of the present invention has especially disclosed the Korean Lotto 6/45 game for illustrative purposes, it can be applicable to all kinds of lottery games throughout the world.

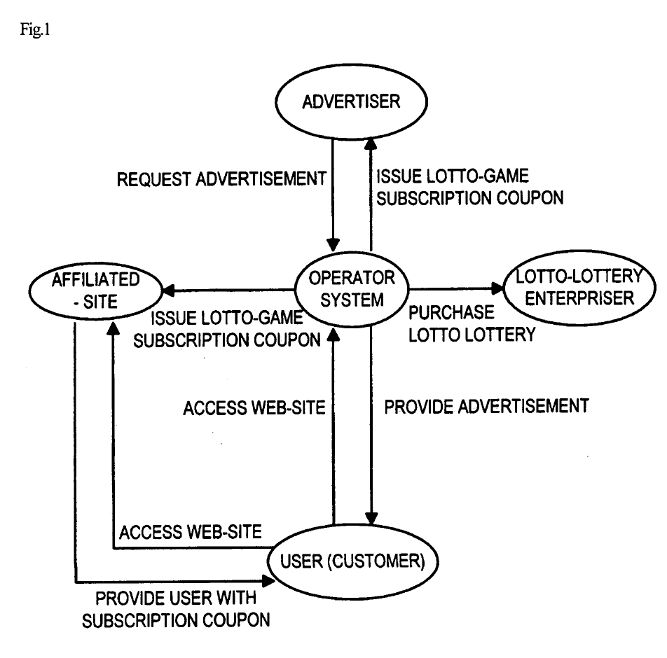

FIG. 1 is a view illustrating a conceptual diagram of an advertising system and method using a lotto lottery game in accordance with an embodiment of the present invention. An advertiser connects to an operator system for providing a user with an advertisement service using a lotto game, and requests the operator system to create an online lotto-game subscription coupon or ticket. Upon receiving this request from the advertiser, the operator systems creates the online lotto-game subscription coupon as requested, and transfers the created subscription coupon to an affiliated Web-site server (i.e., an affiliated-site server). A unique management number for authenticating the lotto-game subscription coupon and the number of available games for each coupon are recorded in the lotto-game subscription coupon. The unique management number contains the date of issuance and effective term information of the subscription coupon, and advertiser ID (Identifier) information for identifying individual advertisers issuing the subscription coupon.

Preferably, the lotto-game subscription coupon is one of a variety of online subscription coupons with an identifying code. However, it may also be manufactured in the form of a physical coupon or ticket. If a customer visits the affiliated-site to register for a membership, or he or she buys commodities or services from the affiliated-site server, the affiliated-site server may issue a lotto-game subscription coupon, in addition to or in the alternative of accumulating cyber money for the customer.

The customer receiving the lotto-game subscription coupon from the affiliated-site server gains access to the operator system, and enters a unique management number recorded on the received lotto-game subscription coupon. The operator system analyzes a unique management number entered by the customer, and verifies the date of issue and effective term information of the subscription coupon. The operator system identifies information of the advertiser who has previously issued the subscription coupon, and displays the advertising contents requested by the advertiser on a screen. In this case, the advertising contents requested by the advertiser may be previously stored in a predetermined database (DB) of the operator system, and may be displayed on a screen upon receipt of a prescribed command from the customer. Alternatively, the advertising contents are hyperlinked to the URL of the advertiser's Web-site, such that they may also be displayed on the advertiser's Web-site if needed.

The advertising contents are displayed for a predetermined period of time, the operator system displays a lotto-game screen picture on a monitor, and display to allow the customer to select his or her desired 6 numbers from among a plurality of numbers 1-45 in such a way that a lotto game is executed.

In this way, if individual customers select their desired lotto numbers from among a plurality of numbers, the operator system gains access to a lotto lottery enterpriser system over a dedicated network in order to purchase a lotto lottery containing the selected lotto numbers, and informs the individual customer of the purchase result information using an E-mail service.

The aforementioned description relates to a post-paid lotto lottery system for allowing the operator system to purchase the lotto lottery at a later time. In more detail, the operator system purchases the lotto lottery from the lotto-lottery enterpriser system on the basis of a customer's desired number.

Alternatively, a pre-paid lotto lottery system may be used. The pre-paid lotto lottery system allows the operator system to purchase a number of lotto lotteries in advance and allows the customers accessing the operator system to select one of the purchased lotto lotteries.

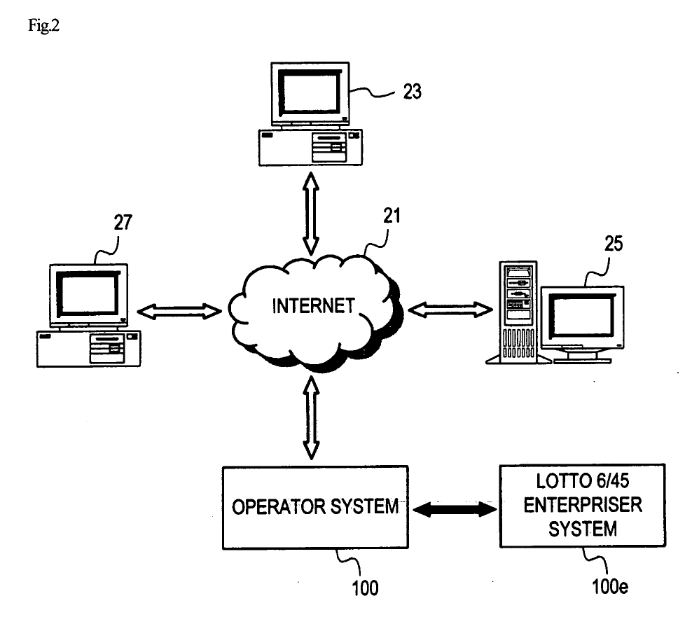

The advertising system and method using such a lotto game according to the present invention will hereinafter be described with reference to FIG. 2.

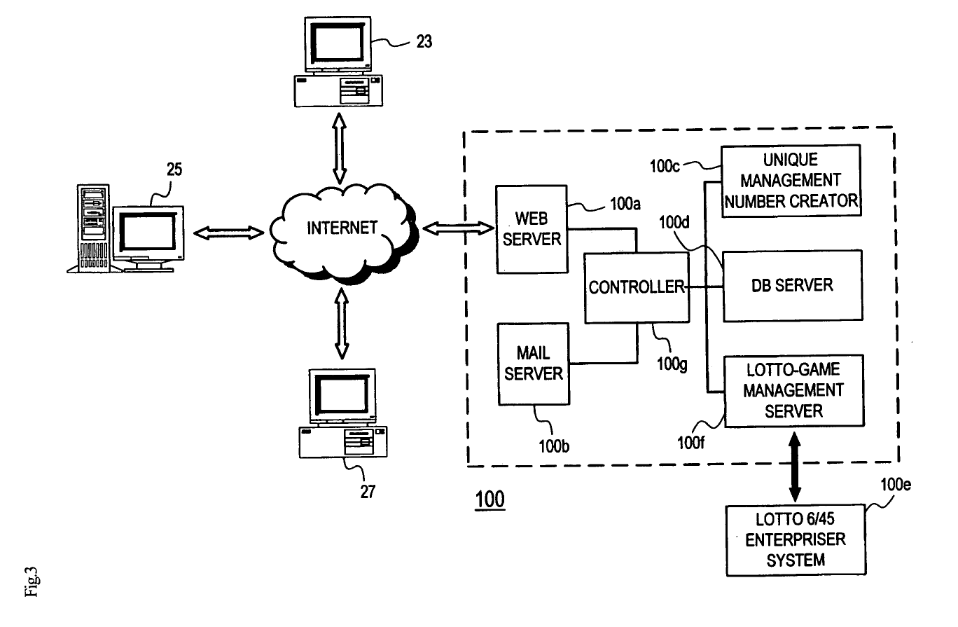

FIG. 2 is a view illustrating a configuration of the advertising system using the lotto game in accordance with an embodiment of the present invention. FIG. 3 is a block diagram of the advertising system shown in FIG. 2 in accordance with an embodiment of the present invention.

Referring to FIG. 2, the advertising system using the lotto game includes, for example, an advertiser server or computer 23 accessing the Internet 21, an affiliated-site server or computer 25, a user server or computer 27, and an operator system 100. The operator system 100 issues an online lotto-game subscription coupon upon receiving a prescribed request from the advertiser. If the user server 27 connected with the operator system 100 enters a unique management number provided on the lotto-game subscription coupon, the operator system identifies the advertiser based on the unique management number, and displays a predetermined advertising message (or an advertising image) of the advertiser to the user, and provides the user with the opportunity of participating in a lotto game in return for the user's viewing or displaying on his screen the advertising message.

Preferably, the advertiser server 23 may serve as an operation server of the advertiser's Web-site, and may be connected using one or more of a variety of communication devices, for example, a PC (Personal Computer), a mobile phone, and a PDA (Personal Digital Assistant) wirelessly connectable to the Internet.

Preferably, the affiliated-site server 25 is an operation server for OAM (Operation, Administration, and Maintenance) controlling the Web-site connected to the Internet 21. The user server 27 may be connected using various means, like a PC connected to the Internet 21, a mobile phone, and a PDA wirelessly connectable to the Internet.

Referring to FIG. 3, the operator system 100 accessing the Internet 21 includes a Web server 100a communicating with the servers (23, 25, 27), a mail server 100b for transferring lotto game number information purchased by the user's clicks and later prize-winning information to the user server 27, a unique management number creator 100c for creating a unique management number for every lotto-game subscription coupon to be issued, and a database (DB) server 100d for storing advertiser information, advertising message information, unique management number information for every lotto game subscription coupon created by the unique management number creator 100c, and various data needed to implement a variety of services of the present invention. The operator system 100 further includes a lotto game management server 100f communicating with the lotto-lottery enterpriser system 100e to provide the user with a lotto game service, and a controller 100g for controlling all the functions of the advertising system such that it can issue a lotto-game subscription coupon, and can provide the user with the advertising message and the lotto game service.

In more detail, the DB server 100d stores membership information, Web-site information, and advertising message information of the advertiser, unique management number of the issued lotto-game subscription coupon, E-mail information of users who gain access to the Internet for the lotto game, and lotto game number information entered by the users, etc.

The unique management number creator 100c contains the date of issue and effective term information of the subscription coupon, and advertiser ID information for identifying individual advertisers.

According to the above-identified advertising system using the lotto game, upon receipt of the advertiser's request, the operator system 100 issues a plurality of online lotto game subscription coupons, and transfers to the affiliated-site server 25 and the advertiser server 23.

If a user who gains access to the Web-site registers as a member in the Web-site or purchases commodities or services from the Web-site, the advertiser server 23 and/or the affiliated-site server 25 provides the user server 27 with a lotto-game subscription coupon on which a unique management number is recorded.

If the user server 27 enters the unique management number provided on the lotto-game subscription coupon, the operator system 100 identifies advertiser information contained in the unique management number such that the user can see the advertising message requested by the advertiser. After the lapse of a predetermined time, the user can also play the lotto game, such that it can encourage the user to aggressively view the advertising message of the advertiser, resulting in the increased advertising effect of the desired advertisement. In an embodiment, the user may register for a membership which allows the user to access the operator system 100 via the user server 27 and can enter a unique management number recorded in the lotto-game subscription coupon. For the membership registration procedure, the user may provide his or her personal information, for example, address, phone-number, E-mail address, and other personal information.

Therefore, upon receiving the unique management number recorded in the lotto-game subscription coupon from the user server 27 registered as a member, the operator system 100 transmits the user's personal information entered in the membership registration procedure to the advertiser server 23.

In this way, the operator system 100 provides the advertiser server 23 with the user's personal information at a time of receiving the unique management number from the user server 27, such that an advertiser stores the personal information of the user receiving a lotto-game subscription coupon issued by the advertiser himself or herself in the form of a database, thereby easily managing and administering the stored information. Furthermore, the stored information can also be adapted as secondary marketing information based on a CRM (Customer Relationship Management).

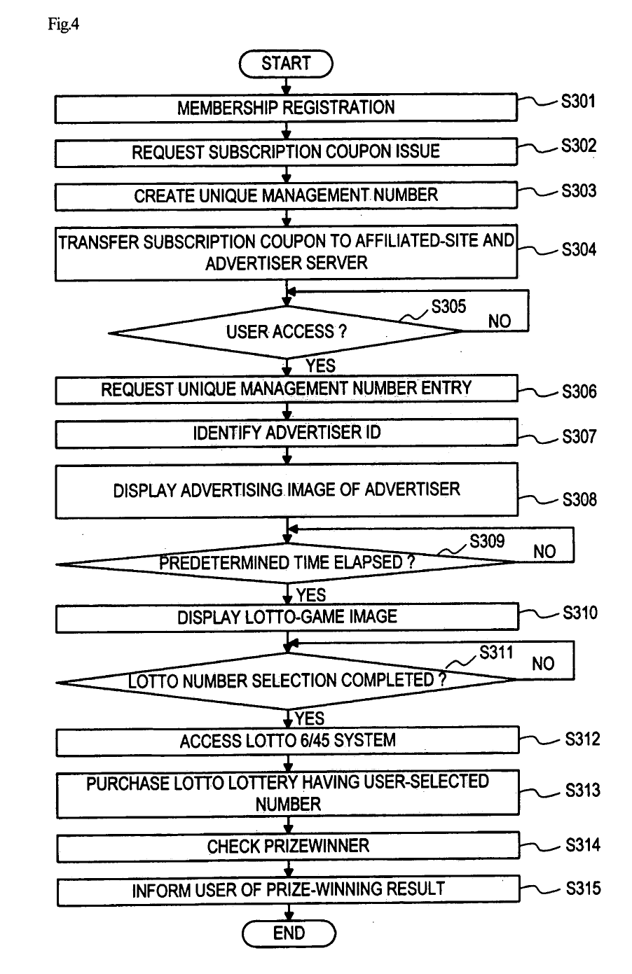

The advertising method using the lotto game according to the present invention will hereinafter be described with reference to FIG. 4. FIG. 4 is a flow chart illustrating the advertising method using the lotto game in accordance with a preferred embodiment of the present invention. Particularly, it should be noted that a post-paid lotto lottery scheme is exemplarily described in FIG. 4 for the convenience of description and better understanding of the present invention.

Referring to FIG. 4, if the advertising system using the lotto game receives a membership registration request from an advertiser who desires to provide users with a predetermined advertising message, the advertiser enters his or her personal information (i.e., membership information) in a registration request sheet provided from the advertising system in such a way that the advertiser registers as a member in the Web-site of the advertising system (step 301). In this case, the membership information may include the advertiser's personal information needed to provide customers with the advertising message using the lotto game, for example, URL, E-mail address, phone number, and business classification information of the advertiser's Web-site, etc.

Upon receiving desired advertising content information and lotto-game subscription coupon issuance request information from the advertiser server 23 (step 302) on the condition that the above-identified membership registration procedure has been completed, the unique management number creator 100c creates a unique management number for every lotto-game subscription coupon to be transferred to the advertiser server 23 and the affiliated-site server 25 (step S303) according to a control signal from the controller 100g. Thereafter, the lotto-game subscription coupon containing the unique management number is transferred to the advertiser server 23 and/or the affiliated-site server 25 via the Web server 100a (step 304).

The lotto-game subscription coupon issuance request information may include the number of subscription coupons to be issued and the number of available games (e.g., one or two games). The advertising content data received from the advertiser server 23 is stored in the DB server 100d.

In this way, if users access the advertiser server 23 and/or the affiliated-site server 25 after the lotto-game subscription coupon has been transferred to the advertiser server 23 and/or the affiliated-site server 23, the advertiser server 23 and/or the affiliated-site server 25 provide the user server 27 with a lotto-game subscription coupon. The issued lotto-game subscription coupon may contain the unique management number information, which is composed of one or more of the date of issuance and effective term information of the subscription coupon, the number of available games, and advertiser ID information.

A user receiving the lotto-game subscription coupon tries to access the operator system 100. If the operator system 100 is connected to the user server 27 over the Internet (step S305), the operator system 100 requests the user to enter a unique management number provided on the received lotto-game subscription coupon in a user authentication request form in order to authenticate the lotto-game subscription coupon (step S306). Upon receipt of a unique management number from the user server 27, the operator system 100 verifies the date of issuance and effective term information of the lotto-game subscription coupon to determine if his or her subscription coupon is valid for the game. The operator system may request the user to register for membership or at least to provide contact information. The user may provide his or her personal information, for example, address, phone-number, E-mail address, and personal interests, etc.

Upon receiving the unique management number recorded in the lotto-game subscription coupon from the user server 27, the operator system 100 may transmit information of the user to the advertiser server 23.

In this way, the operator system 100 provides the advertiser server 23 with the user's information when receiving the unique management number from the user server 27. The advertiser may keep the information of the user receiving a lotto-game subscription coupon issued by itself in the form of a database, thereby easily managing and administering the stored information.

If the lotto-game subscription coupon is not valid due to, for example, expiration of its effective term, the operator system 100 transfers a predetermined message indicating that a lotto game cannot be played using the current subscription coupon to the user server 27. If the lotto-game subscription coupon is valid, the operator system 100 identifies the advertiser from the unique management number (step S307). For reference, an initial screen image is exemplarily shown in FIG. 5 when the user accesses the operator system 100. If the user enters a unique management number provided on the lotto-game subscription coupon in a unique management number entry sheet, and clicks on the Enter button, then the operator system 100 identifies the effective term and advertiser information on the basis of the unique management number entered by the user server 27, as stated above.

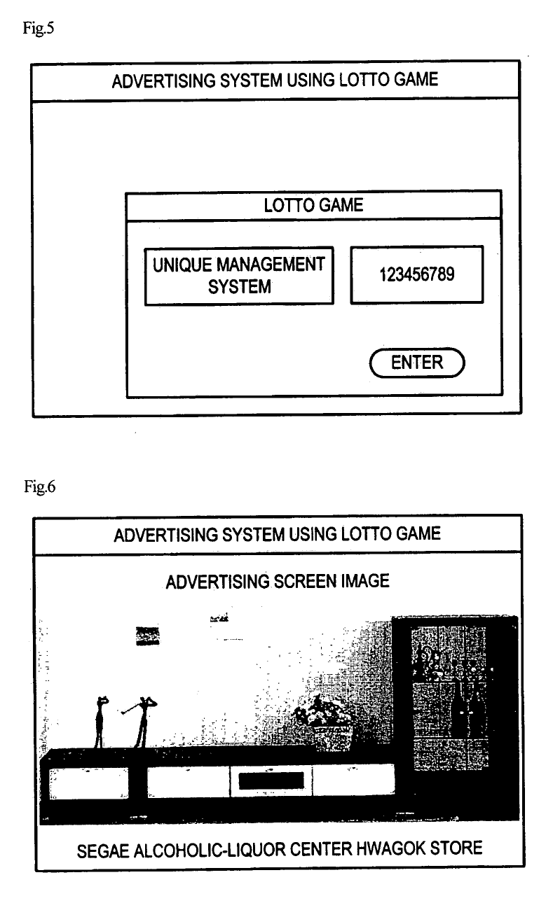

Then, the operator system 100 displays the advertiser's desired advertising image (or message) associated with the subscription coupon (step S308). There are at least two methods for displaying the advertising image: 1) retrieving from the DB server 100d the advertising contents that have been provided in advance by the advertiser, and 2) directly linking the current Web page to the advertiser's Web-site so as to display the advertising image provided directly from the advertiser's Web-site. For reference, an advertising image to be displayed for the user's recognition is exemplarily shown in FIG. 6. The advertising images or messages are displayed for a certain period of time.

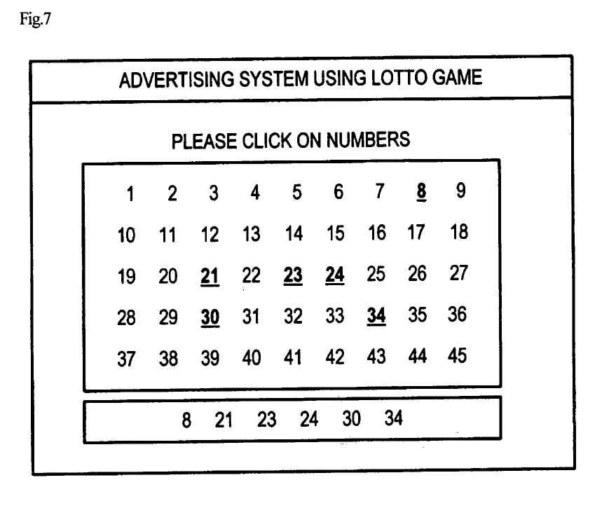

After the lapse of a predetermined time (step S309), the lotto-game management server 100f displays a lotto game image to enable the user to play the lotto game (step S310). The lotto game image is exemplarily shown in FIG. 7. The user selects his or her desired numbers from the displayed numbers, and the lotto-game management server 100f registers the user-selected numbers in the DB server 100d.

If the user selects a desired lotto number (step 311), the lotto-game management server 100f gains access to the lotto-lottery enterpriser system 100e connected through a dedicated line (step S312), purchases the lotto lottery game(s) according to a predetermined number registered in the DB server 100d (step S313), and transmits the information of the purchased lottery game(s) to the user server 27. In the case where the lotto-game management server 100f purchases the lotto lottery game(s) from the lotto-lottery enterpriser system 100e, the user may purchase one lotto lottery for every lotto game, or may purchase a plurality of lotto lotteries at one time on the condition that a sale deadline of the lotto lottery has been previously determined.

Then, the lotto-game management server 100f verifies prizewinners (step S314) after the winning numbers of the lotto lottery has been determined. If the prizewinners are found, the lotto-game management server 100f informs them of their prize-winning status using their E-mail addresses (step S315).

According to the above-described embodiment of the present invention, if the lotto-game subscription coupon is issued by the advertiser's request, and a user receiving the lotto-game subscription coupon gains access to the operator system 100, the operator system 100 identifies the advertiser who has issued the lotto-game subscription coupon, and enables the user to view a desired advertising image or message of the advertiser during a predetermined period of time. Therefore, the user can play a free-of-charge lotto game from the advertiser in return for the user's viewing the advertising messages. The advertiser can provide the user with the opportunity of participating in a lotto game, which motivates the user to view the advertising messages of the advertiser.

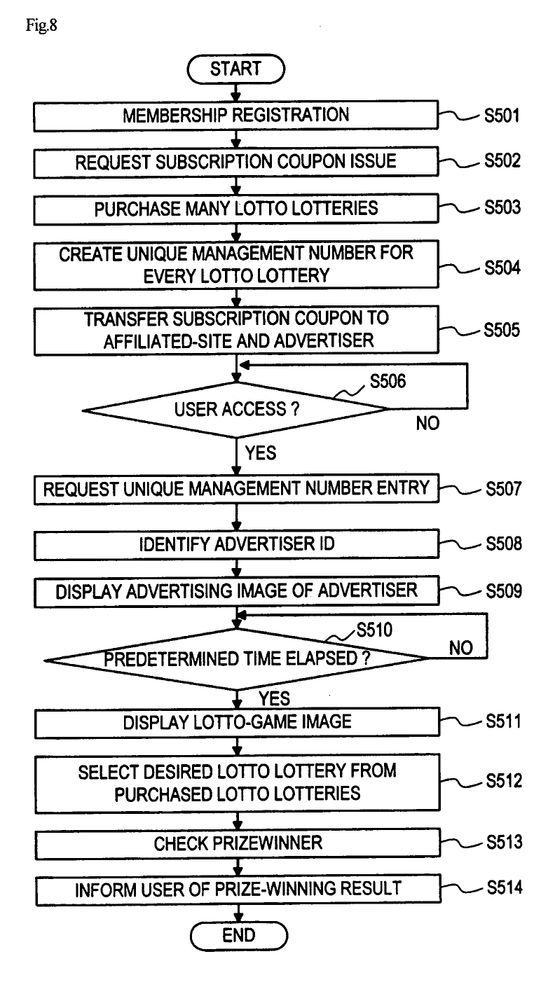

The above-described embodiment of the present invention relates to a post-paid lotto lottery scheme that provides a user with a desired lotto lottery having a specific number on the condition that the user has previously selected the specific number. Another preferred embodiment of the present invention relates to a pre-paid lotto lottery scheme that enables users who gain access to the operator system to select a desired lotto lottery from among a plurality of purchased lotto lotteries on the condition that many lotto lotteries has already been purchased. FIG. 8 is a flow chart illustrating an advertising method using a lotto game in accordance with such embodiment of the present invention. The membership registration procedure and the lotto-game subscription coupon issuance request procedure are the same as those of the previous embodiment of the present invention. Referring to FIG. 8, if the advertising system using the lotto game receives a membership registration request from an advertiser who desires to provide users with an advertising message, the advertiser provides his or her personal information (i.e., membership information) with the advertising system in such a way that the advertiser registers as a member in the Web-site of the advertising system (step 501). The membership information may include the advertiser's personal information needed to provide customers with the advertising message using the lotto game, for example, URL, E-mail address, phone number, and business classification information of the advertiser's Web-site, etc.

Upon receiving desired advertising content information and lotto-game subscription coupon issuance request information from the advertiser server or computer 23 (step 502), the operator system 100 connects to the lotto-lottery enterpriser system 100e, and purchases a certain number of lotto lottery games according to the number of lotto-game subscription coupons requested by the advertiser (step S503).

Then, the unique management number creator 100c of the operator system 100 creates a unique management number for every lotto-game subscription coupon to be transferred to the advertiser server 23 and/or the affiliated-site server 25 (step S504). Thereafter, the lotto-game subscription coupon containing the unique management number is transferred to the advertiser server 23 and/or the affiliated-site server 25 via the Web server 100a (step 505).

As mentioned above, the lotto-game subscription coupon issuance request information may include the number of subscription coupons to be issued and the number of available games for each coupon(e.g., one or two games). The advertising content data received from the advertiser server 23 is stored in the DB server 100d.

When users access the advertiser server 23 and/or the affiliated-site server 25, the advertiser server 23 and/or the affiliated-site server 25 provide the user server 27 with a lotto-game subscription coupon. The lotto-game subscription coupon may contain the unique management number information, which includes the date of issuance and effective term information of the subscription coupon, the number of available games, and advertiser ID information.

The user receiving the lotto-game subscription coupon from the advertiser server 23 and/or the affiliated-site server 25 gains access to the operator system 100. If the operator system 100 is connected to the user server 27 over the Internet (step S506), the operator system 100 requests the user to enter a unique management number provided on the received lotto-game subscription coupon (step S507). Upon receipt of a unique management number from the user server 27, the operator system 100 verifies information associated with the number to determine validity of the coupon for playing a game. The operator system 100 may ask the user to register for a membership. In the case of the membership registration, the user may provide his or her personal information, for example, address, phone-number, E-mail address, and personal interests, etc.

Upon receiving the unique management number recorded in the lotto-game subscription coupon from the user server 27, the operator system 100 may transmit the user's personal information entered in the membership registration procedure to the advertiser server 23.

In this way, the operator system 100 provides the advertiser server 23 with the user's personal information when receiving the unique management number from the user server 27, so that an advertiser can utilize the personal information of the user receiving a lotto-game subscription coupon issued by itself.

If the lotto-game subscription coupon is not valid due to, for example, the expiration of its effective term, the operator system 100 transfers a message stating that a lotto game may not be played using the current subscription coupon to the user server 27. If the lotto-game subscription coupon is still valid, the operator system 100 identifies the advertiser ID information from or with use of the unique management number such that it can verify the advertiser (step S508).

The operator system 100 displays a desired advertising image (or message) of the advertiser who has issued the above-identified subscription coupon to the user (step S509). There are at least two methods for displaying the advertising image; for example, one is retrieving the advertising contents that have been provided in advance by the advertiser from the DB server 100d, and another is directly linking the current Web page to the advertiser's Web-site and displaying the advertising images provided from the advertiser's Web-site.

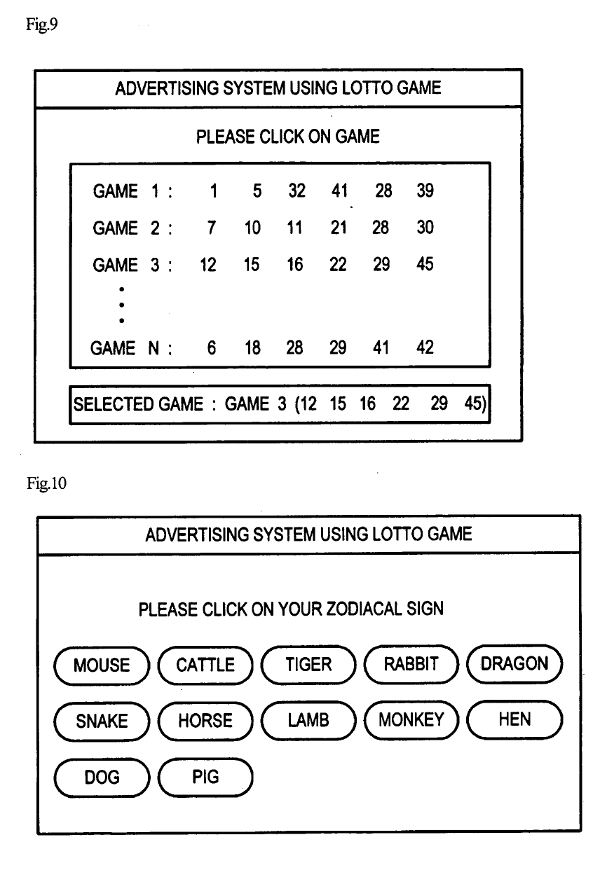

After the lapse of a predetermined time (step S510) for displaying the advertiser's advertising images, the lotto-game management server 100f displays a lotto game page to enable the user to play the lotto game (step S511). FIG. 9 is a view illustrating an exemplary screen image of the lotto game. Unlike the screen illustrated in FIG. 7, allowing users to select desired numbers, this screen lists a plurality of lotto lottery games with pre-selected numbers that have been purchased in advance, from which the user can pick one of the listed lotto lottery games (step S512).

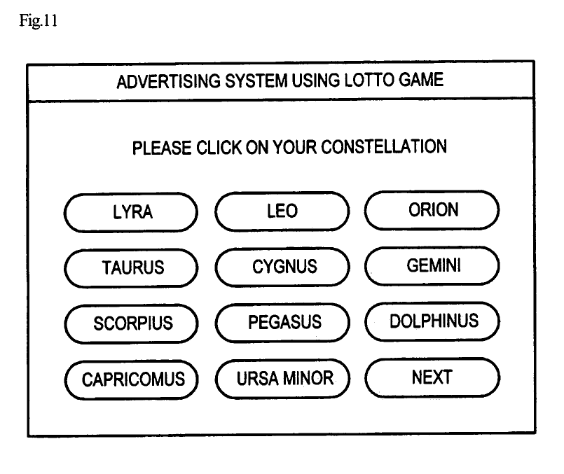

Further, the user may select a lotto lottery game provided from the operator system 100, at his option, with his zodiacal sign, constellation information, and/or the date of user's birth, etc., as shown in FIGS. 10 and 11.

For example, if a screen image shown in FIG. 11 is displayed and the user selects desired constellation information from among constellations displayed on the screen, the lotto-game management server 100f searches for a lotto lottery game assigned to the user-selected constellation. If the lotto-game management server 100f finds at least one lotto lottery game from among a plurality of lotto lottery games, it displays only one lotto lottery game among those found. Thereafter, the user approves the displayed lotto lottery, the approved lotto-lottery number and user information are registered in the DB server 100d, the lotto-game management server 100f transfers the registration result to the user server 27 via the mail server 100b. Alternatively, the plurality of the lottery games are displayed, and the user may select one of them.

Then, if the winning numbers of the lotto lottery game are determined, the operator system 100 compares the winning number with the lottery number registered in the DB server 100d in order to verify prizewinners (step S513). If the prizewinners are found, the operator system 100 informs them of their prize-winning status using their E-mail addresses (step S514).

As apparent from the above description, the advertising system and method using a lotto game according to the present invention can provide a user with a lotto-game subscription coupon in payment for the exposure of advertising messages such that the use can have the opportunity of participating in a free-of-charge lotto game where a huge amount of prize money is available. Therefore, the user may desire to aggressively view the advertising messages of the advertiser by himself or herself because the user can enjoy the lotto game free of charge, resulting in the maximum advertising effect of the desired advertisement.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A computerized advertising system, comprising a server connected to the Internet, the server having a computer program configured to execute a method comprising:
issuing one or more coupons for playing a lottery game to an advertiser, wherein the one or more coupons are designed to be electronically distributed;
receiving a request for playing the lottery game from a lottery player having such a coupon;
determining whether the player's coupon is valid for playing the lottery game;
upon validation of the coupon, enabling to transmit data of an advertisement of the advertiser to a computer device of the player; and
thereafter, permitting the player to play the lottery game.

2. The system of claim 1, wherein the method further comprises purchasing one or more lottery game tickets from a lottery gaming authority.

3. The system of claim 1, wherein the server comprises a code creator configured to create an identification code for each individual coupon, and wherein the identification code is used for the validation of the coupon.

4. The system of claim 1, wherein the server comprises a lottery game manager configured to connect to a computer network of a lottery gaming authority and configured to coordinate the lottery game play.

5. A method of operating advertising services over a computer network, comprising:
issuing one or more coupons for playing a lottery game to a service subscriber, wherein the one or more coupons are configured to be distributed to the public;
receiving a request for playing the lottery game from a lottery player having such a coupon;
determining whether the player's coupon is valid for playing the lottery game;
upon validation of the coupon, enabling to transmit data of an advertisement of the subscriber to a terminal of the player; and
thereafter, permitting the player to play the lottery game.

6. The method of claim 5, wherein the coupons are electronic coupons.

7. The method of claim 5, wherein the coupons are physical coupons.

8. The method of claim 5, wherein the coupons are issued upon a request for such issuance by the subscriber.

9. The method of claim 5, wherein the coupons are distributed to persons who are visiting the subscriber's web site or clicking a banner advertisement of the subscriber on a web site.

10. The method of claim 5, wherein each coupon has a unique identification code.

11. The method of claim 10, wherein the player's coupon is validated based on information associated with the identification code.

12. The method of claim 5, wherein the advertisement is displayed on the terminal for a predetermined period of time.

13. The method of claim 5, wherein, the advertisement data is transmitted from a server belonging to the advertising service.

14. The method of claim 13, further comprising receiving the advertisement data from the subscriber prior to the receipt of the request.

15. The method of claim 5, wherein, the advertisement data is transmitted from a server belonging to the subscriber.

16. The method of claim 5, further comprising purchasing at least one lottery game ticket.

17. The method of claim 16, wherein the at least one lottery game ticket is an electronic ticket.

18. The method of claim 16, wherein the at least one lottery game ticket is purchased from a lottery gaming authority.

19. The method of claim 16, wherein the at least one lottery game ticket is purchased prior to the permission to play the game.

20. The method of claim 19, wherein the at least one lottery game ticket has pre-selected numbers for the lottery game.

21. The method of claim 16, wherein the player selects his own numbers for playing the lottery game as he desires.

22. The method of claim 21, wherein the at least one lottery game ticket is purchased after the selection of the numbers and includes the player selected numbers.

23. The method of claim 5, further comprising informing the player as to whether he has won in the lottery game.

24. A method of playing a lottery game free of charge over a computer network, comprising:
receiving a coupon for playing a free game of lottery, which is made publicly available;
connecting to a web site for the free lottery game play;
transmitting via the computer network to the web site an identification code of the coupon for validation;
upon validation, receiving advertisement data via the computer network;
displaying an advertisement for a predetermined period of time; and
thereafter, connecting to a lottery game free of charge.

25. A computerized advertising system, comprising a server connected to a computer network, the server having a computer program configured to execute a method comprising:
receiving a request for playing a lottery game free of charge, the request being electronically received from a computer device of a player via the computer network;
transmitting or causing to transmit data of an advertisement to the computer device of the player, wherein the advertisement is configured to be displayed in the computer device for a predetermined period of time;
thereafter, permitting the player to play the lottery game free of charge via the computer device; and
wherein the server comprises a lottery game coordinator configured to electronically purchase one or more lottery game tickets from a lottery gaming authority.

26. A computerized advertising system, comprising a server connected to a computer network, the server having a computer program configured to execute a method comprising:
receiving a plurality of electronic coupons issued by a computerized advertising service;
transmitting the electronic coupons to the public via a computer network;
causing a holder of one of the coupons to connect to a server hosting the advertising service;
causing to transmit data of an advertisement to a computer device operated by the coupon holder, wherein the advertisement is displayed on the computer device for a predetermined period; and
allowing the coupon holder to play the lottery game free of charge through the server of the advertising service.

27. The system of claim 26, wherein the advertisement data is transmitted to the computer device from the server hosting the advertising service.

28. The system of claim 26, wherein the advertisement data is transmitted to the computer device from a server belonging to an advertiser of the advertisement.
